(19) United States
(12) Patent Application Publication
(10) Pub. No.: US 2026/0014922 A1
(43) Pub. Date: Jan. 15, 2026

(54) A Vehicle for Mixing Concrete

(71) Applicant: Total Vehicle Solutions Group Limited, Wisbech (GB)

(72) Inventors: Kevin Walker, Wisbech (GB); John Darren Davies, Buckingham (GB); Matthew Hicks, Buckingham (GB)

(21) Appl. No.: 18/995,096

(22) PCT Filed: Jul. 13, 2023
(86) PCT No.: PCT/GB2023/051847

§ 371 Date: Jan. 15, 2025

(30) Foreign Application Priority Data
Jul. 15, 2022 (GB) 2210463.2

(51) Int. Cl. B60P 3/16; B28C 5/42; B60Q 9/00

(52) U.S. Cl. CPC B60P 3/16; B28C 5/4217; B28C 5/422; B28C 5/4272; B60Q 9/00

(57) ABSTRACT

The present invention relates to a vehicle for mixing concrete. The vehicle comprises: a cabin configured to allow an operator to control the vehicle, a chassis comprising a frame configured to support a load on the vehicle, the frame having a longitudinal axis that is substantially parallel to the ground, and a rotatable mixing drum supported on the chassis such that the longitudinal axis of the mixing drum is inclined relative to the longitudinal axis of the frame. The mixing drum comprises a drum ring and being configured to hold and mix a load. The chassis comprises a rear pedestal on which the drum ring of the mixing drum is supported, and the rear pedestal comprises a pair of drum rollers configured to contact the drum ring. The vehicle further comprises at least one stop configured to prevent lateral movement of the rotatable mixing drum beyond a predetermined distance from a centreline of the vehicle.

### TECHNICAL FIELD

The present invention relates to a vehicle for mixing concrete. More specifically, the present invention relates to a vehicle for mixing concrete comprising a mechanism for reducing the likelihood of vehicle roll-over. The present invention also relates to a method for alerting a driver of a vehicle for mixing concrete when the conditions for vehicle roll-over are being approached.

### BACKGROUND

Vehicles for mixing concrete are used to transport concrete to a work site whilst mixing the cement and aggregate payload. An operating concern with vehicles for mixing concrete is that roll moments that are generated when the vehicle is turning can cause the mixing drum to move to an off-centre position, which can cause the vehicle to roll-over. As the vehicle turns, centrifugal force acts on the vehicle in a direction opposite to the direction of the turn. When the vehicle is moving at a speed too high for the radius and camber of the turn, there is a potential that conditions for the mixing drum to move to an off-centre position will be met and therefore an increased chance of vehicle roll-over.

These centrifugal forces are of particular concern when considering the mixing drum, which can often have a mass of in excess of 20 Tons and a high centre of gravity. The lateral forces on the load when cornering can push the load up the internal wall of the mixing drum and the centrifugal forces are compounded by the rotation of the mixing drum, which can cause the load to ‘climb’ the mixing drum, further raising the centre of gravity of the mixing drum. The forces acting on the mixing drum can cause the mixing drum to move off its contact points with the vehicle. In such an event, the mixing drum becomes loose and is able to swing under the above mentioned forces. The loose and swinging mixing drum increases the potential for the vehicle to roll-over.

### SUMMARY

According to the present invention, there is provided a vehicle for mixing concrete. The vehicle comprises: a cabin configured to allow an operator to control the vehicle; a chassis comprising a frame configured to support a load on the vehicle, the frame having a longitudinal axis that is substantially parallel to the ground; a rotatable mixing drum supported on the chassis such that the longitudinal axis of the mixing drum is inclined relative to the longitudinal axis of the frame, the mixing drum comprising a drum ring and being configured to hold and mix a load; wherein the chassis comprises a rear pedestal on which the drum ring of the mixing drum is supported; the rear pedestal comprising a pair of drum rollers configured to contact the drum ring; and at least one stop configured to prevent lateral movement of the rotatable mixing drum beyond a predetermined distance from a centreline of the vehicle.

In some embodiments, the at least one stop may be spaced from the rotatable mixing drum such that there may be a gap between the at least one stop and the rotatable mixing drum.

In some embodiments, the size of the gap between the at least one stop and the rotatable mixing drum may be in the range of 5 mm to 50 mm.

In some embodiments, the size of the gap may be defined by the smallest distance between the rotatable mixing drum and the at least one stop, when the mixing drum is supported by the pair of drum rollers.

In some embodiments, the at least one stop may be positioned so as to contact the drum ring of the mixing drum when the mixing drum moves off of at least one of the pair of drum rollers.

In some embodiments, the at least one stop may be mounted on the rear pedestal.

In some embodiments, the at least one stop may be mounted further in the radial direction from the longitudinal axis of the mixing drum than the drum ring.

In some embodiments, the at least one stop may be located further from the frame of the chassis than the centre of gravity of the mixing drum and a load within the mixing drum.

In some embodiments, the at least one stop may be located at a greater distance from the centreline of the vehicle than at least one of the pair of drum rollers.

In some embodiments, the at least one stop may be located closer to the cabin than the pair of drum rollers.

In some embodiments, the at least one stop may be located between 30 and 90 degrees about the longitudinal axis of the mixing drum from the centre of the pair of drum rollers.

In some embodiments, the vehicle may comprise at least two stops, the two stops may be separated by an angle in the range of about 50 to 60 degrees and spaced equally from the centreline of the vehicle.

In some embodiments, the at least one stop may be mounted on a compressible member on the rear pedestal and may be configured to reduce the impact force of the mixing drum when it contacts the at least one stop.

In some embodiments, the at least one stop may comprise a contact surface configured to contact the mixing drum formed by a low friction surface.

In some embodiments, the low friction surface of the at least one stop may be a rotatable roller.

In some embodiments, an outer surface of the rotatable roller may be formed by a low friction material.

In some embodiments, the low friction surface may be a non-rotatable surface formed by a low friction material.

In some embodiments, the at least one stop may further comprise a contact detection system comprising a contact sensor that is configured to determine whether the mixing drum has contacted the at least one stop and send a signal to an output device when the mixing drum contacts the at least one stop, the output device being configured to alert an operator of the vehicle when the mixing drum contacts the at least one stop.

In some embodiments, the at least one stop may further comprise a load sensing system comprising a load sensor configured to determine the load experience by the at least one stop when the mixing drum contacts the at least one stop and send a signal to an output device, the output device being configured to alert an operator of the vehicle when the load exceeds a predetermined value representative of conditions of an imminent roll-over.

### BRIEF DESCRIPTION OF THE DRAWINGS

Embodiments of the invention will now be described, by way of example only, with reference to the accompanying drawings, in which:

FIG. 1 shows a perspective side view of a vehicle for mixing concrete;

FIG. 2 shows a schematic rear view of a vehicle for mixing concrete including a load at rest and during rotation; and

FIG. 3 shows a schematic rear cross-sectional view in a plane orthogonal to a longitudinal axis of a mixing drum of a vehicle according to an embodiment of the invention.

### DETAILED DESCRIPTION

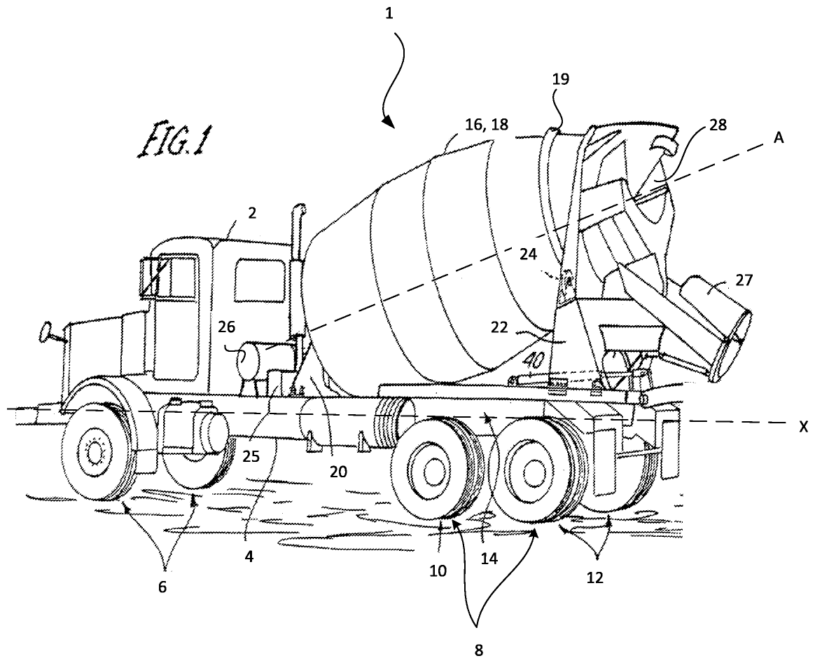

Referring to FIG. 1, a side perspective view of a vehicle 1 for mixing concrete is shown. The vehicle 1 is a concrete mixing truck. The vehicle 1 comprises a cabin 2 and a chassis 4. The vehicle 1 typically has three sets of wheels. A first set of wheels 6 may be located at the cabin 2, and a tandem set of wheels 8 may be located on the chassis 4. The tandem set of wheels 8 may comprise a front truck set of wheels 10 and a rear truck set of wheels 12.

The chassis 4 may comprises a frame 14. The frame 14 forms a base onto which further features of the vehicle 1 can be mounted. The frame 14 extends generally horizontally such that its longitudinal axis X extends substantially parallel to the ground. The plane that extends vertically from the longitudinal axis X that extends along the centre of the vehicle 1 may be referred to as the centreline Y of the vehicle 1. The vehicle 1 further comprises a mixing drum 16. The mixing drum 16 is configured to hold and mix concrete. The mixing drum 16 is configured to mix a load 17 by rotating about its central longitudinal axis A, as will be described in more detail hereinafter. In the present embodiment, the load 17 is concrete.

The mixing drum 16 comprises an outer skin 18 and a drum ring 19. The drum ring 19 extends about the circumference of an outer surface of the outer skin 18 of the mixing drum 16. The plane in which the drum ring 19 extends is substantially perpendicular to the central longitudinal axis A of the mixing drum 16. The drum ring 19 may be stronger than the drum skin 17. The drum ring 19 may be formed from, for example, but not limited to, a ring of hard steel.

The mixing drum 16 is supported by the frame 14 of the chassis 4. The chassis 4 comprises a first pedestal 20 located at the front of the frame 14, also known as a front support, and a second pedestal 22, located at the rear of the frame 14, also known as a rear support stool. The mixing drum 16 is supported by the first and second pedestals 20, 22 and allowed to rotate relative thereto.

As shown in FIG. 1, the second pedestal 22 extends further from the frame 14 than the first pedestal 20. Therefore, the second pedestal 22 at the rear of the frame 14 has a greater height than the first pedestal 20 at the front of the frame 14. The difference in height of the first and second pedestal 20, 22 allows the rear of the mixing drum 16 to be supported at an elevated height compared to the front of the mixing drum 16. That is, the central longitudinal axis A of the mixing drum 16 is inclined relative to the longitudinal axis X of the frame 14 of the chassis 4.

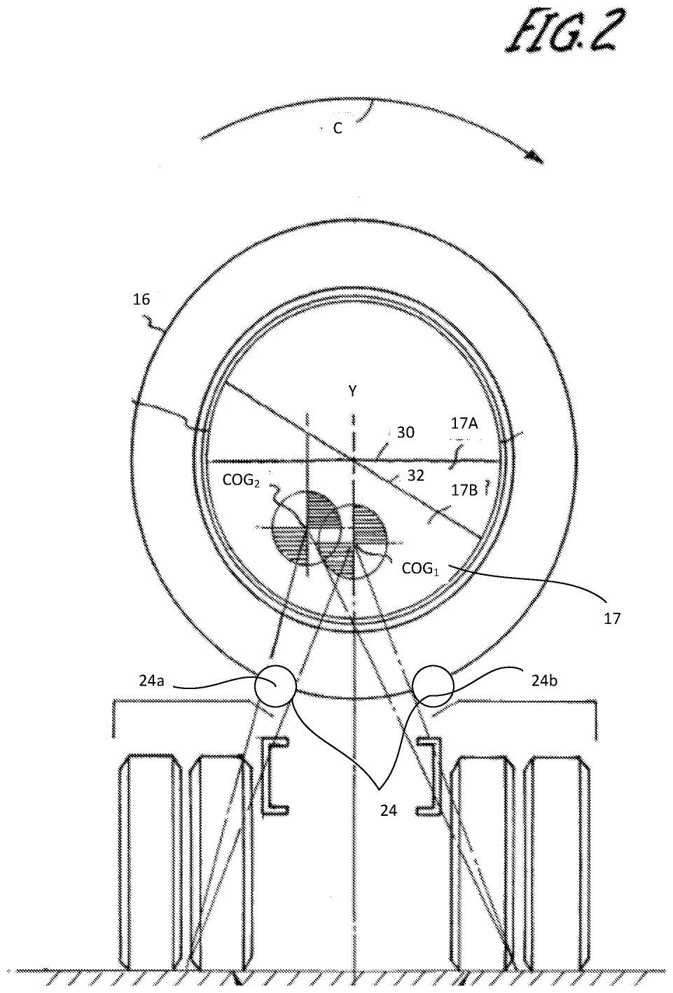

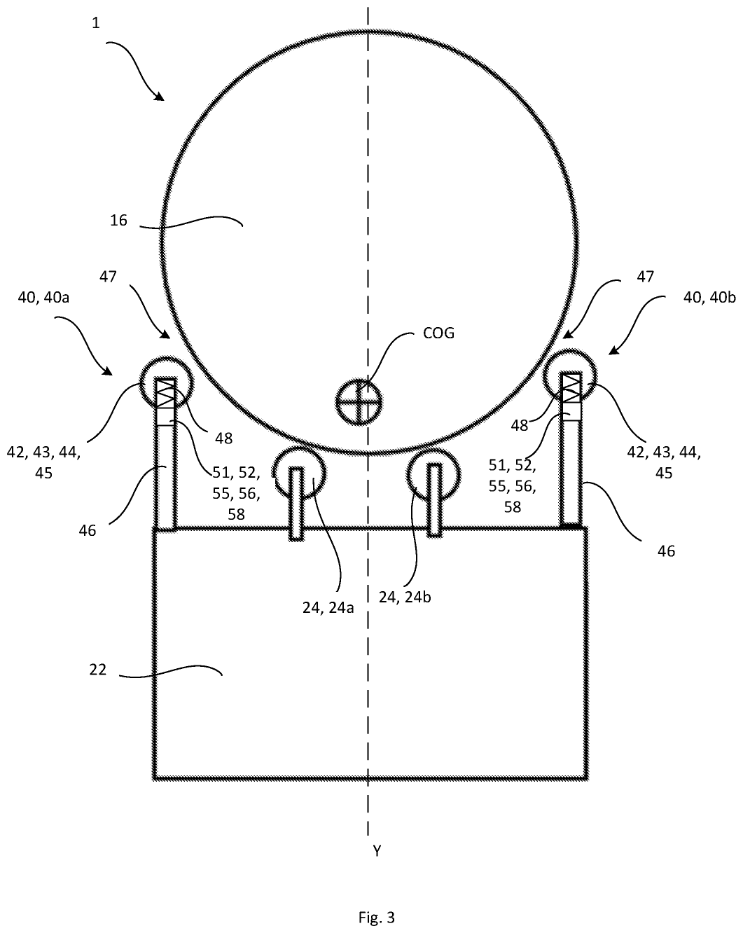

The chassis 4 further comprises a pair of drum rollers 24. The pair of drum rollers 24 comprise a port side roller 24a and a starboard side roller 24b, shown in FIG. 2 and FIG. 3, which are located on opposing side of a centreline Y of the vehicle 1. In the present embodiment, the drum rollers 24a, 24b are attached to the rear pedestal 22, or rear support stool. The drum rollers 24a, 24b engage a rear part of the mixing drum 16. In the present embodiment, the drum rollers 24a, 24b engage the drum ring 19. The drum rollers 24 support the mixing drum 16 on the rear pedestal 22 and allow rotation of the mixing drum 16 about its central longitudinal axis A.

The first pedestal 20 of the vehicle 1 may further comprise a gearbox 25, which controls rotation of the mixing drum 16 to mix the concrete. The gearbox 25 may be configured to allow rotation of the mixing drum 16 about three orthogonal axes. Thus, the mixing drum 16 can pivot about the first pedestal 20 in any direction. The vehicle 1 may further comprise a drum motor 26. The drum motor 26 may be configured to provide the rotational force to rotate the mixing drum 16. The drum motor 26 can be powered by an electric motor, by a hydraulic motor, or by the engine of the vehicle 1. The gearbox 25 may connect the drum motor 26 to the mixing drum 16 to transmit and convert the power supplied by the drum motor 26 to the correct rotational speed of the mixing drum 16.

The vehicle 1 may further comprise a chute 27, which is located proximate to a discharge opening 28 of the mixing drum 16, such that the load 17 can be delivered via the chute 27 from the mixing drum 16 to a worksite.

Due to the elevated height at which the rear of the mixing drum 16 is supported by the rear pedestal 22 compared to the front of the mixing drum 16 on the front pedestal 20, or inclined angle between the frame 14 and the central longitudinal axis A of the mixing drum 16, the discharge opening 28 of the mixing drum 16 is elevated. This enables the mixing drum 16 to carry a larger load 17 without spilling the load 17 out of the discharge opening 28.

Referring now to FIG. 2, it can be seen that the larger the load 17 within the mixing drum 16, enabled by the inclination of the rear of the mixing drum 16 relative to the frame 14, raises the centre of gravity of the mixing drum 16 and its load 17. Therefore, when the mixing drum 16 is not rotating the centre of gravity, shown by the label COG₁ in FIG. 2, of the mixing drum 16 and the load 17 is centred relative to the centreline Y, or longitudinal axis X, of the vehicle 1. In FIG. 2, the centre of gravity COG₁ of the mixing drum 16 and the load 17 is shown as being higher than the pair of drum rollers 24 with respect to the frame 14. However, it will be understood that this is merely for illustration purposes, and that in most, but not necessarily all, cases, the centre of gravity COG₁ of the mixing drum 16 and its load 17 may be below or at least in line with the position of the pair of drum rollers 24.

When the load 17 is not being rotated it is in what is known as a dead load position 17A. When in the dead load position 17A, an upper surface 30 of the load 17 is substantially level, i.e. horizontal. The height of the centre of gravity COG₁ of the dead load 17 is determined by the volume and density of the load 17 within the mixing drum 16. Furthermore, the centre of gravity COG₁ of the mixing drum 16 and the load 17 is vertically in line with the rotational axis A of the mixing drum 16 when there are no lateral forces of the mixing drum 16 due to the vehicle 1 turning.

To mix the load 17 in the mixing drum 16, the mixing drum 16 is rotated about its longitudinal axis A. The mixing drum 16 may be rotated clockwise as shown in FIG. 2 by arrow C when viewed from the rear of the vehicle 1, i.e. the opposite end of the vehicle 1 to the cabin 2. Thus, the following description relates to forces and centre of gravity in relation to clockwise rotation of the mixing drum 16. However, it will be appreciated that the mixing drum 16 may alternatively be rotated anti-clockwise and that all the forces and positioning of the centre of gravity may be opposite to the description given below.

As the mixing drum 16 rotates in the clockwise direction C, the load 17 is caused to move by the motion of the mixing drum 16. The load 17 rises, or shifts laterally, up the port side of the inner surface of the mixing drum 16. The leftwards lateral shift of the load 17 also causes the load 17 to rise up the inner surface of the mixing drum 16, which causes the centre of gravity, shown by label COG₂ in FIG. 2, to move upwards and to the left of the centreline Y of the vehicle 1, when viewed from the rear of the vehicle 1.

When the load 17 is being rotated it is in what is known as a live load position 17B. The live load position 17B and the load's centre of gravity COG₂ is determined by the volume, density, and viscosity of the load 17 and the rotational velocity of the mixing 20) drum 16. The live load position 17B and the load's centre of gravity COG₂ is also affected by the movement of an internal screw (not shown in the drawings) within the mixing drum 16 and the geometry of the internal screw. Different configurations of the internal screw, such as radius and pitch will affect the extent to which the load is mixed and/or lifted up the internal surface of the mixing drum 16. These factors will further affect the 25 live load position 17B and the load's centre of gravity COG₂. When in the live load position 17B, an upper surface 32 of the load 17 is inclined with respect to the horizontal or dead load position 17A. A part of the upper surface 32 of the load 17 in the live load position 17B may be above the location of the upper surface 30 of the load 17 when the load 17 is in the dead load position 17A, as shown in FIG. 2. Furthermore, a 30 part of the upper surface 32 of the load 17 in the live load position 17B may be below the location of the upper surface 30 of the load 17 when the load 17 is in the dead load position 17A, as shown in FIG. 2.

The movement of the centre of gravity COG of the load 17 away from the centreline Y of 35 the vehicle 1 and vertically upwards during rotation of the mixing drum 16 further narrows the operating window of the vehicle 1 before the mixing drum 16 becomes unseated from the pair of rollers 24, i.e. enters an off-centre position and/or conditions for roll-over are met.

More specifically, the raising and movement of the centre of gravity away from the centreline Y of the vehicle 1 means that less centrifugal, or lateral, force is required for the mixing drum 16 to come off of the pair of drum rollers 24 that support the mixing drum 16. Once the lateral force due to turning, based on corner radius and camber, and vehicle velocity, is sufficient for the mixing drum 16 to move off at least one of the rollers and/or up and over one of the pair of drum rollers 24, then the mixing drum 16 and load 17 are able to swing away from the centreline Y of the vehicle 1 unopposed. The large movement in the centre of gravity COG, as well as the momentum of the large mass and the impulse created if/when the movement of the mixing drum 16 is halted, increases the likelihood of the vehicle 1 rolling over.

The aim of the present invention, as outlined below, is to prevent the centre of gravity COG of the mixing drum 16 and load 17 from moving to such an extent that the mixing drum 16 of the vehicle 1 is caused to move off of at least one of the pair of drum rollers 24 into an off-centre position when the vehicle operator navigates a turn too quickly. By preventing, or at least limiting, the mixing drum 16 from moving laterally relative to the rest of the vehicle 1, the present invention also aims to reduce the risk of vehicle roll-over.

Referring to FIG. 3, a schematic cross-sectional view of an embodiment of the invention is shown. The cross-sectional view shown in FIG. 3 is of a plane that extends orthogonally to the longitudinal axis A of the mixing drum 16. The cross-sectional view shown in FIG. 3 illustrates a cross-section of the mixing drum 16 and the rear pedestal 22 of a vehicle 1 for mixing concrete.

The schematic cross-sectional view of FIG. 3 shows the rear pedestal 22 and the pair of drum rollers 24 extending from the rear pedestal 22. The pair of drum rollers 24 are located centrally on the rear pedestal 22. That is, each of the rollers 24a, 24b of the pair of rollers 24 are spaced by the same distance from the centreline Y of the vehicle 1.

Each of the drum rollers 24a, 24b of the pair of drum rollers 24 extend to the same vertical height. Thus, when the mixing drum 16 rests on the pair of drum rollers 24, the mixing drum 16 is located centrally on the rear pedestal 22. That is, the central longitudinal axis A of the mixing drum 16 is located in the same vertically extending plane as the centreline of the vehicle 1. In addition, the centre of gravity COG of the mixing drum 16 and the load 17 is located between drum rollers 24a, 24b of the pair of drum rollers 24 in the horizontal direction.

In the present invention, the vehicle 1 further comprises at least one stop 40. The at least one stop 40 is configured to prevent, or at least constrain, movement of the mixing drum 16 beyond a predetermined distance from the centreline Y of the vehicle 1. The at least one stop 40 of this present embodiment is configured to limit lateral movement of the mixing drum 16 relative to the vehicle 1.

In the embodiment shown in FIG. 3, the vehicle 1 comprises two stops 40a, 40b. That is, the vehicle 1 comprises a port side stop 40a and a starboard side spot 40b. The port side stop 40a is configured to constrain movement of the mixing drum 16 to the left of the centreline of the vehicle 1. The starboard side stop 40b is configured to constrain movement of the mixing drum 16 to the right of the centreline of the vehicle 1. Although the present embodiment has two stops, it will be appreciated that the vehicle 1 may comprise a single stop or more than two stops.

The at least one stop 40 is configured to provide a surface against which the mixing drum 16 abuts when the mixing drum 16 becomes unseated from its central position on the pair of drum rollers 24. That is, when the forces acting on the mixing drum 16 exceed a minimum value, the mixing drum 16 lifts off one of the pair of drum rollers 24 and begins to roll over the other one of the pair of drum rollers 24. As the mixing drum 16 continues to move away from the centreline Y of the vehicle 1, the momentum of the mixing drum 16 increases. However, by placing the at least one stop 40 in the path of the mixing drum 16, the momentum gained by the mixing drum 16 before it contacts the at least one stop 40 is significantly less than a freely swinging mass, such that the at least one stop 40 may prevent further movement of the mixing drum 16 away from the centreline Y of the vehicle 1 or even cause the mixing drum 16 to return to its normal central position.

The at least one stop 40 may comprise a contact surface 42 that is configured to contact the mixing drum 16 to resist any further movement of the mixing drum 16 away from the centreline Y of the vehicle 1 to prevent the mixing drum from swinging freely if it becomes unseated from the pair of roller 24. The contact surface 42 is configured to contact the drum ring 19 of the mixing drum 16 when the mixing drum 16 moves under lateral forces. In some embodiments, the contact surface 42 configured to contact the mixing drum 16 is formed by a low-friction surface 43. A low-friction surface 43 is advantageous because, without friction, the low-friction surface prevents the mixing drum 16 from gripping the stop 40 and rolling over the stop 40. That is, the drum ring 19 slips against the low-friction surface 43 rather than gripping and rolling over it.

In the present embodiment, the at least one stop 40 is formed by a rotatable roller 44. The rotatable roller 44 has an outer circumferential surface 45, which can be considered to be a low-friction surface 43 because it is free to rotate under contact such that it will rotate in the opposite direction to the rotation of the mixing drum 16 and the mixing drum 16 will only slip on the rotatable roller 44. In some embodiments, the outer circumferential surface 45 of the rotatable roller 44 may be formed by a low friction material. The low-friction material may be, for example, but not limited to, nylon.

The roller 44 is connected to the chassis 4 by a support arm 46. The support arm 46 may connect the roller 44 to the rear pedestal 22. Alternatively, the support arm 46 may connect the roller 44 directly to the frame 14 of the chassis 4. The support arm 46 is configured to withstand at least the lateral load of the mixing drum 16 and load 17 moving away from the centreline Y of the vehicle 1. The support arm 46 may be configured to withstand a lateral load of up to between 0.5 g and 1 g, for example, 0.7 g. That is, the support arm 46 may be configured to withstand a lateral load of up to about 20 T.

In an alternative embodiment, the low-friction surface 43 may be formed by a non-rotatable surface, i.e. not a rotatable roller 44. That is, the low-friction surface 43 may be designed such that it is a low-friction contact surface located at the end of a support arm 46. A non-rotatable low-friction contact surface may be profiled in order to reduce the likelihood of the mixing drum 16 gripping against and rolling over the stop 40.

The at least one stop 40 is spaced from the mixing drum 16 such that there is a gap 47 between the at least one stop 40 and the mixing drum 16. The size of the gap 47 between the at least one stop 40 and mixing drum 16 is defined by the smallest distance between the mixing drum 16 and the at least one stop 40. The size of the gap 47 between the at least one stop 40 and the mixing drum 16 is in the range of 5 mm to 50 mm. The size of the gap 47 between the at least one stop 40 and the mixing drum is more preferably in the range of 10 mm to 20 mm.

The at least one stop 40 may be mounted on a compressible member 48 on the rear pedestal 22 of the chassis 4 of the vehicle 1. The compressible member 48 may be configured to reduce the impact force of the mixing drum 16 when it contacts the at least one stop 40. Thus, the forces related to the impulse created when the mixing drum 16 contacts the at least one stop 40 may be reduced and the chance of the vehicle rolling over due to the swinging mixing drum 16 is reduced. The compressible member 48 may be, for example, but not limited to, a spring or a bushing. The bushing may optionally be made of rubber.

Furthermore, the at least one stop 40 may further comprise a contact detection system 51. The contact detection system 51 may comprise a contact sensor 52. The contact sensor 52 may be configured to determine whether the mixing drum 16 has contacted the at least one stop 40. The contact sensor 51 may further be configured to send a signal to an output device 53 in the cabin 2 when the mixing drum 16 contacts the at least one stop 40. Alternatively, the signal may be sent by a separate controller 54. The output device 53 may be configured to alert an operator of the vehicle 1 when the mixing drum 16 contacts the at least one stop 40. The output device 53 may comprise, for example, but not limited to, a speaker configured to play a warning sound or a video output device configured to display a warning or a flashing light.

In addition, the at least one stop 40 may further comprise a load sensing system 55. The load sensing system 55 may be a part of the contact detection system 51. The load sensing system 55 may comprise a load sensor 56. The load sensor 56 may be configured to determine the load experience by the at least one stop 40 when the mixing drum 16 contacts that at least one stop 40. The load sensor 56 may further be configured to send a signal to an output device 57 in the cabin 2 when the mixing drum 16 contacts the at least one stop 40. Alternatively, the signal may be sent by a separate controller 58. The output device 57 may be configured to alert an operator of the vehicle 1 when the load on the mixing drum 1 exceeds a predetermined value representative of the conditions of an imminent roll-over of the vehicle 1. The output device 53 may comprise, for example, but not limited to, a speaker configured to play a warning sound or a video output device configured to display a warning or a flashing light. In addition, the load sensing system 55 may be used to determine when the at least one stop 40 require replacing due to experiencing an excessive loading event.

In the present embodiment, the at least one stop 40 is mounted further in the radial direction from the longitudinal axis A of the mixing drum 16 than the drum ring 19. Furthermore, as can be seen from FIG. 3, the at least one stop 40 is located at a greater distance from the centreline Y of the vehicle 1 than at least one 24a, 24b of the pair of drum rollers 24.

As a result of the wider placement of the at least one stop 40 compared to the pair of drum rollers 24, the at least one stop 40 is also located closer to the cabin 2 than the pair of drum rollers 24 to ensure that contact between the at least one stop 40 and the mixing drum 16 still occurs on the drum ring 19 due to the inclination angle of the longitudinal axis A of the mixing drum 16.

In addition, as a result of the wider placement of the at least one stop 40 compared to the pair of drum rollers 24, the at least one stop 40 is located further from the frame 14 of the chassis 4 than the pair of drum rollers 24. Thus, the mixing drum 16 has to move vertically upwards to move over the at least one stop 40 instead of only moving laterally. This increases the amount of force required for the mixing drum 16 to move further from the centreline Y of the vehicle 1, as will be explained in more detail below.

By preventing the centre of gravity COG of the mixing drum 16 and its load 17 from moving away from the centreline Y of the vehicle 1 by a significant distance, the at least one stop 40 helps to reduce the likelihood of the vehicle 1 rolling over under conditions where the mixing drum 16 is moved off of at least one of the pair of drum rollers 24. In some embodiments, the contact surface 42 of the at least one stop 40 is located at a horizontal distance from the centreline of the vehicle 1 which is at least 80% of the radius length of the mixing drum 16.

It has been determined by the inventors that the placement of the at least one stop 40 prevents the mixing drum 16 from swinging freely and potentially causing the vehicle 1 to roll-over by providing a contact surface that is located outside of the vector of the resultant force acting on the mixing drum 16. The resultant force acting on the mixing drum 16 is a result of a number of factors.

The main factors include the mass, and therefore weight, of the mixing drum 16 and its load, the lateral forces on the mixing drum 16 and load 17 caused by the vehicle 1 cornering, and the position of the centre of gravity COG of the mixing drum 16 and the load 17. The weight of the mixing drum 16 and its load 17 act vertically downwards under the force of gravity. The gravitational and lateral forces can be considered to act at the combined centre of mass COG of the mixing drum 16 and load 17. The lateral forces due to cornering act laterally, or perpendicularly to the force of gravity, which have been discussed in detail above.

When the product of the forces are considered, the resultant force generally acts at an angle to the vertical. As the components of the lateral force increase due to larger cornering speeds or due to a heavier load being carried, the overall force vector extends at a larger angle to the vertical. Movement of the load 17 up the inner surface of the mixing drum 16 also causes a shift in the centre of gravity COG of the load 17, as explained in detail above.

Other factors contribute to the direction and magnitude of the resultant force vector of the mixing drum 16 too. For example, vehicle 1 roll as it corners effects the direction of the resultant force vector relative to the pair of drum rollers 24. In addition, vehicle 1 heave as it travels over bumps can cause an upward force on the mixing drum 16 and load 17, which can reduce the vertical component of the resultant force vector such that the resultant force vector acts outside of the contact points of the mixing drum 16 with the pair of drum rollers 24.

All these factors can lead to the resultant force vector acting outside of the contact points on the pair of drum rollers 24, which can cause the mixing drum 16 to become unseated and begin to swing. However, the introduction of the at least one stop 40 to the vehicle 1 provides another contact point that the resultant force vector is still within. Therefore, the mixing drum 16 is prevented from freely swinging and the likelihood of vehicle 1 roll-over is reduced.

In order to swing freely, the resultant force vector of the mixing drum 16 must act outside of the at least one stop 40. Therefore, a loose mixing drum 16 can be prevented by predetermined placement of the at least one stop 40 by taking into account the above mentioned factors.

When the centre of gravity of the mixing drum 16 and the load 17 is below the contact point of the mixing drum 16 with the pair of drum rollers 24, the mixing drum 16 is unlikely to swing freely. However, lateral forces from cornering and bumps in the road can lead to events where the resultant force vector on the mixing drum 16 acts outside of the contact point and causes the mixing drum 16 to swing. Once the mixing drum 16 is swinging freely it can be difficult to stop and may possible cause the vehicle 1 to roll-over. Thus, the at least one stop 40 helps to arrest the movement of the mixing drum 16 before it becomes too great to stop. As long as the resultant vector of the forces acting on the mixing drum 16 act between the at least one stop 40 and the vertical, the mixing drum 16 will be prevented from swinging freely.

In some embodiments, the at least one stop 40 is also located further from the frame 14 of the chassis 4 than the centre of gravity COG of the mixing drum 16 and the load 17 within the mixing drum 16. By having the contact surface 43 of the at least one stop 40 above the centre of gravity COG of the mixing drum 16 and its load 17, the mass of the mixing drum 16 and load 17 are less likely to move up and over the at least one stop 40. In some embodiments, the contact surface 42 of the at least one stop 40 is located at a vertical distance from the pair of rollers 24 which is at least 50% of the vertical distance between the pair of rollers 24 and the centre of gravity of the mixing drum 16 and its load 17 when there are no external lateral forces acting on the vehicle 1. The vertical distance may be taken to be relative to the frame 14 or in the plane extending orthogonally to the longitudinal axis of the mixing drum 16.

Preferably, the at least one stop 40 is located between 30 and 90 degrees about the longitudinal axis A of the mixing drum 16 from the centre of the pair of drum rollers 24. That is, the centreline Y of the vehicle 1 extends in a vertical plane, which includes the rotational longitudinal axis A of the mixing drum 16. The centreline Y of the vehicle that extends in a vertical plane passes through the middle of the pair of drum rollers 24 such that each roller 24a, 24b is equidistantly spaced from the centreline Y of the vehicle 1. Thus, the at least one stop 40 is preferably located between 30 and 90 degrees about the longitudinal axis A of the mixing drum from the vertical plane extending downwards from the longitudinal axis A of the mixing drum 16 through the centre of the pair of drum rollers 24.

In some embodiments, the two stops 40a, 40b may have an angle of separation of between 60 and 180 degrees about the rotational axis A of the mixing drum 16 and the stops 40a, 40b may be equally spaced from the centreline Y of the vehicle 1. That is, the two stops 40a, 40b may be placed between 30 and 90 degrees on opposing sides of a plane extending vertically form the centreline of the vehicle 1. Preferably, the two stops 40a, 40b may have an angle of separation of between 80 and 120 degrees +/−5 degrees about the rotational axis A of the mixing drum 16 and the stops 40a, 40b may be equally spaced from the centreline Y of the vehicle 1. That is, the two stops 40a, 40b may be placed between 40 and 60 degrees on opposing sides of a plane extending vertically form the centreline of the vehicle 1. Preferably, the two stops 40a, 40b are placed at the same vertical height.

The larger the angle between the vertical plane extending downwards from the longitudinal axis A of the mixing drum 16 and the at least one stop 40 about the longitudinal axis A of the mixing drum 16, the higher up the at least one stop 40 can be placed relative to the centre of gravity COG of the mixing drum 16 and the load 17 in the mixing drum 16, and the further towards the cabin 2 the at least one stop 40 has to be placed.

By having the at least one stop 40 located at a larger angle relative to the centreline of the pair of drum rollers 42, the size of the gap 43 in the lateral direction (i.e. not necessarily the shortest distance) is larger compared to a smaller angle. Thus, the mixing drum 16 and load 17 can gain more momentum before the mixing drum 16 contacts the at least one stop 40 because it is able to travel a larger distance and so accelerate to a greater velocity. Thus, the larger the angle between the at least one stop 40 and the centreline between the pair of drum rollers 42, the larger the force the at least one stop 40 and supporting arm 45 must be able to withstand. However, due to the higher placement of the at least one stop 40, there is less chance of the mixing drum 16 moving up over the at least one stop 40 when the mixing drum 16 moves off of at least one of the pair of drum rollers 24 and swinging freely. Thus, there is a significantly reduced chance of the vehicle 1 rolling over.

In addition, the smaller the angle between the at least one stop 40 and the centreline between the pair of drum rollers 24, the smaller the momentum of the mixing drum 16 and it load 17 when the mixing drum 16 contacts the at least one stop 40. The smaller angle means a smaller lateral distance exists between the mixing drum 16 and the at least one stop 40 and so the support arm 45 does not have to withstand as large a force and can be shorter and less prone to bending or buckling. However, the smaller angle means that there is a smaller vertical distance between the at least one stop 40 and the centre of gravity COG of the mixing drum 16 and so there is a higher chance of the mixing drum 16 moving over the top of the at least one stop 40.

Thus, when there are sufficient lateral forces of the mixing drum 16 to lift the mixing drum 16 off of at least one of the pair of drum rollers 24, the mixing drum 16 will move away from the centreline of the vehicle 1. For example, if an operator of the vehicle 1 turns to the right to quickly, the inertia of the mixing drum 16 and its load 17 may cause the mixing drum 16 to move to the left relative to the centreline Y of the vehicle 1. As the mixing drum 16 moves relative to the chassis 4 of the vehicle 1, the mixing drum 16 may pivot about or roll over the port side roller 24a of the pair of drum rollers 24 and therefore move out of contact with the starboard roller 24b of the pair of drum rollers 24. After the mixing drum 16 has moved a predetermined distance in the lateral direction, the mixing drum 16 contacts the at least one stop 40 on the left side of the vehicle 1, which prevents further movement of the mixing drum 16 away from the centreline 16.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, mean, etc., other than those specifically described herein. In addition, this disclosure may include other inventions not presently claimed, but which may be claimed in future.

1. A vehicle for mixing concrete, the vehicle comprising:
a cabin configured to allow an operator to control the vehicle;
a chassis comprising a frame configured to support a load on the vehicle, the frame having a longitudinal axis that is substantially parallel to the ground;
a rotatable mixing drum supported on the chassis such that the longitudinal axis of the mixing drum is inclined relative to the longitudinal axis of the frame, the mixing drum comprising a drum ring and being configured to hold and mix a load;
wherein the chassis comprises a rear pedestal on which the drum ring of the mixing drum is supported;
the rear pedestal comprising a pair of drum rollers configured to contact the drum ring; and
at least one stop configured to prevent lateral movement of the rotatable mixing drum beyond a predetermined distance from a centreline of the vehicle.

2. The vehicle according to claim 1, wherein the at least one stop is spaced from the rotatable mixing drum such that there is a gap between the at least one stop and the rotatable mixing drum.

3. The vehicle according to claim 2, wherein the size of the gap between the at least one stop and the rotatable mixing drum is in the range of 5 mm to 50 mm.

4. The vehicle according to claim 3, wherein the size of the gap is defined by the smallest distance between the rotatable mixing drum and the at least one stop, when the mixing drum is supported by the pair of drum rollers.

5. The vehicle according to any one of claim 2 to claim 4, wherein the at least one stop is positioned so as to contact the drum ring of the mixing drum when the mixing drum moves off of at least one of the pair of drum rollers.

6. The vehicle according to any one of the preceding claims, wherein the at least one stop is mounted on the rear pedestal.

7. The vehicle according to claim 6, wherein the at least one stop is mounted further in the radial direction from the longitudinal axis of the mixing drum than the drum ring.

8. The vehicle according to any one of claim 6 or claim 7, wherein the at least one stop is located further from the frame of the chassis than the centre of gravity of the mixing drum and a load within the mixing drum.

9. The vehicle according to any one of claim 6 to claim 8, wherein the at least one stop is located at a greater distance from the centreline of the vehicle than at least one of the pair of drum rollers.

10. The vehicle according to claim 9, wherein the at least one stop is located closer to the cabin than the pair of drum rollers.

11. The vehicle according to claim 9 or claim 10, wherein the at least one stop is located between 30 and 90 degrees about the longitudinal axis A of the mixing drum from the centre of the pair of drum rollers.

12. The vehicle according to claim 11, comprising at least two stops, the two stops being separated by an angle in the range of about 50 to 60 degrees and spaced equally from the centreline of the vehicle.

13. The vehicle according to any one of claim 6 to claim 12, wherein the at least one stop is mounted on a compressible member on the rear pedestal and is configured to reduce the impact force of the mixing drum when it contacts the at least one stop.

14. The vehicle according to any one of the preceding claims, wherein the at least one stop comprises a contact surface configured to contact the mixing drum formed by a low friction surface.

15. The vehicle according to claim 14, wherein the low friction surface of the at least one stop is a rotatable roller.

16. The vehicle according to claim 15, wherein an outer surface of the rotatable roller is formed by a low friction material.

17. The vehicle according to claim 14, wherein the low friction surface is a non-rotatable surface formed by a low friction material.

18. The vehicle according to any one of the preceding claims, wherein the at least one stop further comprises a contact detection system comprising a contact sensor that is configured to determine whether the mixing drum has contacted the at least one stop and send a signal to an output device when the mixing drum contacts the at least one stop, the output device being configured to alert an operator of the vehicle when the mixing drum contacts the at least one stop.

19. The vehicle according to any one of the preceding claims, wherein the at least one stop further comprises a load sensing system comprising a load sensor configured to determine the load experience by the at least one stop when the mixing drum contacts the at least one stop and send a signal to an output device, the output device being configured to alert an operator of the vehicle when the load exceeds a predetermined value representative of conditions of an imminent roll-over.
